(19) United States
(12) Patent Application Publication
(10) Pub. No.: US 2015/0146556 A1
(43) Pub. Date: May 28, 2015

(54) BASE STATION APPARATUS, WIRELESS COMMUNICATION METHOD AND CENTRAL CONTROL SERVER

(71) Applicant: HITACHI, LTD., Chiyoda-ku, Tokyo (JP)

(72) Inventors: Meng Zheng, Beijing (CN); Lu Geng, Beijing (CN); Yunjian Jia, Tokyo (JP)

(21) Appl. No.: 14/399,817

(22) PCT Filed: May 10, 2013
(86) PCT No.: PCT/CN2013/075436

§ 371 Date: Nov. 7, 2014

(30) Foreign Application Priority Data
May 11, 2012 (CN) 201210147114.X

(51) Int. Cl. H04W 72/12; H04B 7/02; H04W 88/08; H04W 24/10

(52) U.S. Cl. CPC H04W 72/1263; H04W 24/10; H04B 7/024; H04W 88/08
USPC 370/252; 370/329

(57) ABSTRACT

It is provided a base station apparatus that uses a plurality of coordinated Multiple Points (CoMP) schemes, and is connected to a plurality of subordinate transmission points for transmitting data, comprising: a transceiver unit, located at the transmission point, that receives and transmits data from and to a terminal; a data processing unit that extracts non-periodic feedback information and periodic feedback information from the data received via the transceiver unit from the terminal; a CoMP scheme selection unit that selects a CoMP scheme to be applied to the terminal from a plurality of CoMP schemes based on the non-periodic feedback information; and a scheduling unit that performs scheduling with use of the selected CoMP scheme based on the non-periodic feedback information and periodic feedback information, and transmits data to the terminal via a corresponding transceiver unit.

### BACKGROUND OF THE INVENTION

This invention relates generally to a method, base station device and central control server for transmitting data to a terminal by a base station acted as wireless communication device, and more particularly, to a method, base station device and central control server for transmitting data to a terminal by a base station which is able to select a appropriate Coordinated Multi-Point scheme from a plurality of Coordinated Multi-Point schemes for downlink data transmission.

Coordinated Multi-Point (abbreviated as “CoMP”) is considered to be a good approach for expending the coverage of high rate data service in cellular network, improving the throughput at the edge of cell and the system average throughput.

For explanation purposes, hereinafter, a user terminal is referred to as “UE”, a transmission point is referred to as “TP”, and a base station is referred to as “BS”. The so-called “uplink” direction refers to the direction from the UE to a TP (BS), and the so-called “downlink” direction refers to the direction from a TP (BS) to the UE.

The conventional CoMP technology will be described below with reference to FIG. 9.

FIG. 9 is a diagram of a typical application scene for prior CoMP technology in a simplified cellular network. In FIG. 9, a transmission point 901 (hereinafter referred to as “TP1”) and a transmission point 902 (hereinafter referred to as “TP2”) independently form a wireless coverage area, as a cell formed by that transmission point. Each of TP1 and TP2 are connected to base station 905 to which them belong via a fiber 906, and use the fiber 906 as data interface to exchange baseband data with the base station 905. UE1 and UE2 distributed in the corresponding cell may achieve wireless access and data transfer functions by establishing a TP1-UE1 link 911 and a TP2-UE2 link 912 respectively. In some special cases, UE may be located at the junction of two cells, such as UE1 in FIG. 9. Although accessing to network via TP1, UE1 is very closed to the cell covered by TP2. If the frequency used by a system is the same as that in the neighboring cell, and TP2 provides data transmission for UE2 while TP1 performing data transmission to UE1 via TP1-UE1 link 911, the formed TP2-UE1 interference link 913 would collide with TP1-UE1 link 911, resulting as quality degradation of wireless link detected by UE1. The CoMP technology is proposed to solve the problem that the signal quality of UE is poor at the edge of cell.

With respect to the application of CoMP technology, 3GPP (3rd Generation Partnership Project) currently is widely asking for opinions. According to the content of the proposal, three kinds of CoMP technologies have been determined to be used: (1) Centralized Scheduling/Beamforming, CS/CB, (2) Dynamic Point Selection/Blanking, DPS/DPB, and (3) Joint Transmission, JT. Each of these three kinds of CoMP technique requires free and fast data and control signaling interaction between TPs, and differentiates the transmission mode of physical signals for the UE.

Three kind of prior CoMP technologies will be described below in reference to FIGS. 10-12. FIG. 10 is an application example diagram illustrating a prior CS/CB technology in a typical scenario. FIG. 11 is an application example diagram illustrating a prior DPS/DPB technology in a typical scenario. FIG. 12 is an application example diagram illustrating a prior JT technology in a typical scenario. The same components as FIG. 9 are denoted with same reference numerals, and the description thereof is omitted.

The CS/CB technology, via a centralized scheduling module, uniformly schedules the UEs within the coverage of TP1 and TP2 in a scenario, and minimizes the interference to the scheduled UEs within the coverage of the other TP due to the transmission within the coverage of TP1 and TP2 by beamforming technology in a multi-antenna technology. As illustrated in FIG. 10, when employing the CS/CB technology, TP1 and TP2 will share the scheduling information for the UEs within respective coverage. TP2 may use an appropriate beamforming preprocess so that the signal power transmitted by TP2 over UE1's interference link 913 can be eliminated or minimized, and thus improving the signal interference noise ratio (SINR) over TP1-UE1 link 906.

The DPS/DPB technology may make the UE to select the physical link with the highest SINR for data transmission by collecting timely and comparing the link quality condition between one UE and different TPs. As illustrated in FIG. 11, when employing DPS technology, UE1 may select a link having the best quality from TP1-UE1 link 911 and TP2-UE1 link 1101 as data transmission link. If TP2-UE1 link 1101 is selected as data transmission link for UE1, UE2 which could have been scheduled into cell of TP2 can not be scheduled. Meanwhile, if TP1 schedules the other UEs within the coverage itself, such as UE1103 (hereinafter abbreviated as “UE3”), TP1 will become the interfering source to UE1. For further improving the signal quality of UE1, TP1 does not schedule any UE (such as UE3) at that time, i.e., performing silent processing to TP1, so as to further improving data channel quality of UE1.

The JT technology may make TP1 and TP2 to share the transmission data for UE1, and conduct a joint transmission. As illustrated in FIG. 12, using JT technology, the previous interfering link may be converted to TP2-UE1 link 1101 that transmits the useful signals. Since the signals from TP1 and TP2 are received by UE1 at same time, the quality of links may be improved significantly by effective aggregation, thus effectively improving their data throughput.

Since the different physical methods used for the signal transmission, each of these three technologies exist advantages and disadvantages.

The CS/CB technology achieves the improving of channel quality for UE by a way of interference cancellation, of which the advantage is that based on a optimized precoding processing, different cells still can simultaneously serve different UEs and the spatial multiplexing efficiency will not be reduced. However, the precoding processes taking into account the interference canceling function may result in an effective decrease in signal strength, and this technology is subject to a greater influence of the pre-existing precoding codebook accuracy.

The DPS/DPB technology may improve the system performance by increasing the scheduling flexibility on the network side, while increase the signal quality of UEs at the edge of cell by TP silent processing. It is the most convenient and flexible way in the CoMP technology, which requires minimal changes to the existing systems. However, the disadvantage is that it cannot really effectively enhance the signal quality of UEs at the edge of cell without TP silent, and with TP silent, it is possible to reduce the efficiency of the spatial multiplexing and this would introduce a variety of different combinations of interfering signals, so that channel quality estimation complexity on the UE side may be increased.

The JT technology may achieve the purposes of increasing in the effective signal strength and reducing the interference signal intensity meanwhile by conducting cooperative transmission between neighboring TPs. On the basis of this, UE can obtain the best channel quality among these three schemes. The disadvantage of JT technology is that it will reduce the spatial multiplexing efficiency, and JT scheme requires a higher network synchronization, thus being difficult to obtain reliable aggregation gain for some scenes in the present standard specification.

In summary, only supporting a single CoMP technology in existing networks may be difficult to truly improve system performance and UE performance at cell edge field under a variety of complex scenes. Therefore, it is necessary to introduce new function modules in existing systems to support the use and switching of a variety of CoMP techniques by a optimized design of unified feedback.

In 3GPP TS 36.213, a feedback system in the existing LTE system is described. The feedback in the LTE system consists of PUCCH (Physical Uplink Control Channel)-based periodic feedback and PUSCH (Physical Uplink Shared Channel)-based non-periodic feedback. Each of feedback information consists of Rank Indicator (RI) or Channel Quality Indicator (CQI) having different frequency field granularity (broadband or narrowband) and Precoding Matrix Indicator. With the carrier aggregation, the Channel State Information (CSI) for different cells may be transmitted in the manner of time division multiplexing by a plurality of PUCCH multiplexed in the time field, and CSIs for a plurality of cells may be transmitted over one PUSCH by RRC layer signaling configuration. However, although capable of supporting CSI transmissions for a plurality of cells in this present mechanism, a specific approach for cooperation between the base stations are not considered, which results in the lack of support for corresponding signaling and the lack of possible optimization for specific CoMP scheme, and thus the transmission efficiency is low.

In 3GPP WG1 R1-120982, two feedback schemes are defined: per-resource feedback and multi-resource feedback. The PUSCH-based non-periodic feedback may support these two feedback schemes simultaneously. However, the time division multiplexing PUCCH-based periodic feedback only support per-resource feedback well and cannot provide adequate support for multi-resource feedback due to the limited capacity. Using time division multiplexing PUCCH feedback approach meanwhile will introduce a larger feedback delay, which will bring a very negative impact on CoMP implementations, in particular for the JT CoMP.

In 3GPP WG1 R1-121090, proposed to define a new feedback information format to support transmission of relevant information between the CSI-RS-resource in the JT mode, such as phase difference between CSI-RS-resource or aggregated CQI generated based on a plurality of CSI-RS-resources; also proposed that in addition to transmitting a plurality of CSI over PUCCH in a manner of time division multiplexing, a plurality of CSI may be incorporated into the same PUCCH for transmission to reduce the impact of time-field delay. The problem with this method is that, for simultaneous existence of CPI and PMI feedback, this incorporation may require a larger data capacity, which may exceed the capacity limitation for PUCCH. In fact, for the delay sensitivity CoMP scheme, in particularly JT CoMP, the problem of delay and capacity may be solved by supporting aggregated CSI feedback in feedback.

In general, for JT CoMP, the problems of the time-division multiplexing transmission delay and huge overhead issue may be addressed by introducing the aggregated CSI feedback in the periodic feedback. Thus, when designing the overall feedback scheme, the aggregated CSI feedback should be introduced into the framework, and using the PUCCH to implement a various of CoMP schemes may be supported by adding the corresponding module in the network, providing function of switching CoMP scheme under appropriate conditions.

### SUMMARY OF THE INVENTION

The present invention is proposed in view of the above issue, its object is to provide a method, base station device and central control server for transmitting data to a terminal by a base station in order to support the use and switching of a plurality of CoMP technologies.

In accordance with an embodiment of this invention, an base station apparatus that uses the plurality of coordinated Multiple Points (CoMP) schemes, and is connected to a plurality of subordinate transmission points for transmitting data, comprising: a transceiver unit, located at the transmission point (TP), that receives and transmits data from and to a terminal (UE); a data processing unit that extracts non-periodic feedback information and periodic feedback information from the data received via the transceiver unit from the terminal; a CoMP scheme selection unit that selects a CoMP scheme to be applied to the terminal from a plurality of CoMP schemes based on the non-periodic feedback information; and a scheduling unit that performs scheduling with use of the selected CoMP scheme based on the non-periodic feedback information and periodic feedback information, and transmits data to the terminal via a corresponding transceiver unit.

In accordance with an embodiment of this invention, a method for transmitting data to a terminal by a base station comprising: a non-periodic feedback information receiving step of receiving non-periodic feedback information via a transceiver unit from the terminal; a CoMP scheme selecting step of selecting a CoMP scheme to be applied to the terminal from a plurality of CoMP schemes based on the received non-periodic feedback information; a periodic feedback information receiving step of receiving periodic feedback information from the terminal; and a scheduling step of allocating scheduling with use of the selected CoMP scheme based on the non-periodic feedback information and the periodic feedback information, and transmitting data to the terminal via a corresponding transceiver unit.

In accordance with an embodiment of this invention, a central control server coupled to a plurality of the base station that coupled to a terminal, comprising: a coordinated Multiple Points (CoMP) scheme selection unit configured to select a CoMP scheme to be applied to the terminal from a plurality of CoMP schemes based on non-periodic feedback information obtained by the base station from the terminal; and a scheduling unit configured to allocate scheduling with the selected CoMP scheme based on the non-periodic feedback information and periodic feedback information obtained by the base station from the terminal, and notify a corresponding base station of transmitting data to the terminal.

The base station, method for transmitting data to a terminal and central control server comprises a CoMP selection unit (step) and scheduling unit (step), so that it is able to select a suitable CoMP scheme for each UE, based on the current load condition of network and channel condition of each UE, by non-periodic feedback information included in the PUSCH-based data upload by the UE. Meanwhile, based on the non-periodic feedback information and periodic feedback information from the UE, the selected suitable CoMP scheme may be used to perform scheduling for providing UE a efficient downlink data transmission service. Since an embodiment of this invention enhances the flexibility of scheduling, maximize network utilization efficiency of radio resources, the network performance can be effectively improved.

### BRIEF DESCRIPTION OF THE DRAWINGS

FIG. 1 is a typical structure example diagram illustrating a base station that supports CoMP scheme selection and transmission according to the present invention.

FIG. 2 is a schematic flow diagram illustrating a method for supporting CoMP scheme selection and transmission according to the present invention.

FIG. 3 is a schematic format diagram illustrating a format for a feedback information mode format that supports CoMP scheme selection and transmission according to the present invention.

FIG. 4 is a format diagram illustrating an example of a format for a load state information storage table according to the present invention.

FIG. 5 is a format diagram illustrating an example of a format for a channel state information storage table according to the present invention.

FIG. 6 is a schematic flow diagram illustrating CoMP selection and scheduling according to the present invention.

FIG. 7 is a schematic diagram illustrating a format for a PUCCH-based periodic feedback information mode which uses aggregated CSI feedback to support JT CoMP transmission according to the present invention.

FIG. 8 is a schematic diagram illustrating system architecture for using a central control server to support CoMP scheme selection and transmission according to the present invention.

FIG. 9 is a simplified diagram illustrating a application of existing CoMP technology in a typical scenario.

FIG. 10 is an example diagram illustrating a application of existing CS/CB technology in a typical scenario.

FIG. 11 is an example diagram illustrating a application of existing DPS/DPB technology in a typical scenario.

FIG. 12 is an example diagram illustrating a application of existing JT technology in a typical scenario.

### DETAILED DESCRIPTION OF THE PREFERRED EMBODIMENT

With reference to the drawings, specific embodiments of the present invention are now described with respect to a complete CoMP scheme selection and data transfer process by two cells cooperatively. The existing concept of cell refers to the coverage of “a base station”, “a sector of a base station”, “a home base station”, or a “transmission point” etc. For simplicity of description, the term “a cel”” refers to the coverage of a “TP” herein.

<Base Station and a Method for Transmitting Data to Terminals from the Base Station>

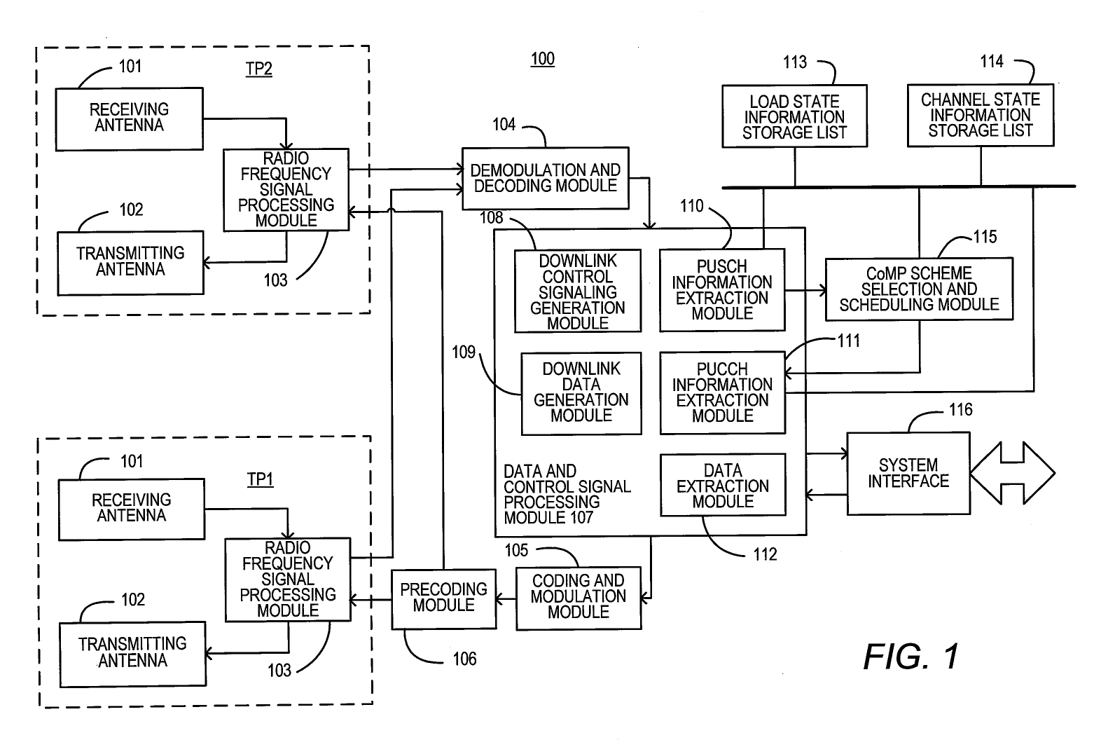

FIG. 1 is a typical structure schematic diagram illustrating a base station that supports use and selection of various CoMP schemes in accordance with an embodiment of this invention. In the embodiment of this invention illustrated in FIG. 1, the function of selection of CoMP schemes and data transmission may be implemented by adding a CoMP selection and scheduling module 115 in a base station.

As illustrated in FIG. 1, base station 100 may include a plurality of TP (TP1 and TP2) that connected to it, for example, via a fiber, and generally external to base station 100. Each of TPs mainly implements functions of processing, transmitting and receiving of Radio frequency bands, and the TPs themselves do not have separate baseband processing function. TP1 and TP2 each include a receiving antenna 101 for receiving data, a transmitting antenna 102 for transmitting data and a radio frequency signal processing module 103 for processing the received and transmitted data.

The base station 100 also includes a demodulation and decoding module 104, a coding and modulation module 105, a precoding module 106, a data and control signal processing module 107, a load state information storage table 113, a channel state information storage table 114, a CoMP scheme selection and scheduling module 115 (Coordinated Multiple Points scheme selection unit and scheduling unit), and system interfaces 116. The data and control signal processing module 107 may include a downlink control signaling generation module 108, a downlink data generation module 109, a PUSCH information extraction module 110, a PUCCH information extraction module and a data extraction module 112.

The receiving antenna 101 may receive uplink data from the UE (for convenience of description, all of data, signals and instructions etc. will be collectively referred to as “data” herein), and transmit them to the radio frequency signal processing module 103. The radio frequency signal processing module 103 may perform some simple radio frequency processes on the uplink data from the UE, and transmit the obtained baseband signals to demodulation and decoding module 104 of the base station. Additionally, the radio frequency signal processing module 103 may process the downlink data to be transmitted to the UE to obtain radio frequency signals, and then transmit the RF signals to the transmitting antenna 102. The transmitting antenna 102 may transmit the RF signals to the corresponding UE.

The demodulation and decoding module 104 may perform demodulation and decoding on data from the radio frequency signal processing module 103, and output the results to the data and control signal processing module 107.

The data and control signal processing module 107 may generate and receive data or control signaling, and exchange data with higher layer or external network via system interfaces 116. The PUSCH information extraction module 110 may separate the non-periodic feedback information for different cells in the data carried over PUSCH in a predetermined format to extract the non-periodic feedback information to obtain the information included in the non-periodic feedback information (such as Channel State Information, CSI), output the obtained information to the CoMP scheme selection and scheduling module 115, and then update the load state information storage table 113 and channel state information storage table 114. The PUCCH information extraction module 111 may separate the periodic feedback information in the data carried over PUCCH in a predetermined format to extract the periodic feedback information to obtain the information included in the periodic feedback information (such as Channel State Information, CSI), and then update the load state information storage table 113 and channel state information storage table 114.

The CoMP scheme selection and scheduling module 115 may select a CoMP scheme based on the non-periodic feedback information from the UE, and perform scheduling upon selecting a CoMP scheme for transmitting downlink data to the UE.

The data extraction module 112 may extract downlink data from the UE for further processing. The downlink control signaling generation module 108 and downlink data generation module 109 may generate downlink data (merely user data without signaling) separately based on the process results of CoMP scheme selection and scheduling from the CoMP scheme selection and scheduling module 115, and send to the coding and modulation module 105. The coding and modulation module 105 encodes and modulates the received data, and send the results to the precoding module 106. The precoding module 106 performs precoding operation to form baseband signals to be transmitted to the UE.

By way of example and not limitation, a configuration of the base station in the embodiment of this invention is described above. Various changes may be made on the base station illustrated in FIG. 1.

For example, a storage unit (not shown) may be included for storing the load state information storage table 113 and channel state information storage table 114. Rather in a table form, the information used by a base station to perform CoMP scheme selection and scheduling may also be stored in other ways.

Also, the CoMP scheme selection and scheduling module 115 may be separated to a CoMP scheme selection module and a scheduling module that implement CoMP scheme selection and scheduling respectively.

Also, the number of TP, UE is not limited to the illustration, and may be 1 or any other number.

In other words, the modules illustrated in FIG. 1 may be separated or combined as long as the base station has units for implementing the basic functions thereof as following. That is, the base station receives various data from UEs via a transceiver unit of TP (for example, receiving antenna 101), and extracts, by data processing unit (for example, PUSCH information extraction module 110 and PUCCH information extraction module 111), non-periodic feedback information and periodic feedback information in the received data from the UEs. A CoMP scheme selection unit (for example, CoMP scheme selection and scheduling module 115) selects a CoMP scheme suitable for that UE from a plurality of CoMP schemes based on the non-periodic feedback information. A scheduling unit (for example, CoMP scheme selection and scheduling module 115) uses the selected CoMP scheme to schedule, and performs downlink data transmission to the UE via the transceiver unit (for example, transmitting antenna 102).

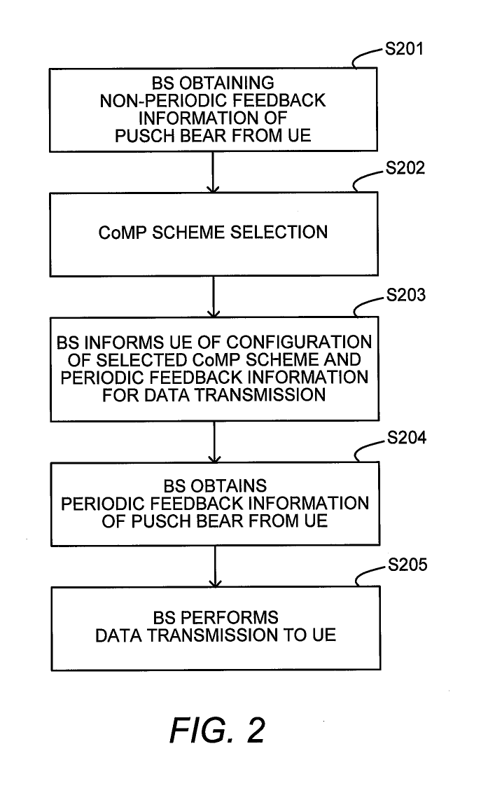

With reference to FIG. 2, a flow of the embodiment of this invention is described below.

FIG. 2 is a schematic flow diagram according to the embodiment of this invention. As illustrated in FIG. 2, firstly, a base station may obtain enhanced non-periodic feedback information carried over PUSCH in the uplink data received from the UE via receiving antenna 101 (transceiver unit) (step S201). The transmission of the PUSCH-based non-periodic feedback information may be triggered by a indication from the base station to the UE during the initialization, or during the transmission, after a data requesting uploaded by the UE is granted by the base station, triggered by a indication from the base station to the UE, or triggered by other ways in the existing standards.

Next, based on the received non-periodic feedback information, the base station selects the most suitable CoMP scheme for the UE from a plurality of CoMP schemes via CoMP scheme selection and scheduling module 115 (step S202).

Then, the base station informs the UE of the selected CoMP scheme and the corresponding configuration parameters of the periodic feedback information by signaling, and after that, uses the selected CoMP scheme to perform scheduling via CoMP scheme selection and scheduling module 115 with the non-periodic feedback information received over the PUSCH for allocating resources for data transmission to the UE (step S203).

During the data transmission, the base station receives uplink data from the UE via the transceiver unit, and obtains the enhanced periodic feedback information carried over PUCCH (step S204).

Based on the obtained periodic feedback information in combination with the previous received non-periodic feedback information or the required information stored in the channel state information storage table 614 and load state information storage table 613, the base station may use the selected CoMP scheme to allocate resources for data transmission to the UE (step S205). The step S204 to S205 may be repeated until a new non-periodic feedback transferred based on PUSCH is triggered or received.

The present invention can select a suitable CoMP scheme for the UE and perform scheduling for providing downlink data transmission to the UE, which can enhance the flexibility of scheduling, maximize the utilization efficiency of radio resources within networks and effectively improve network performance.

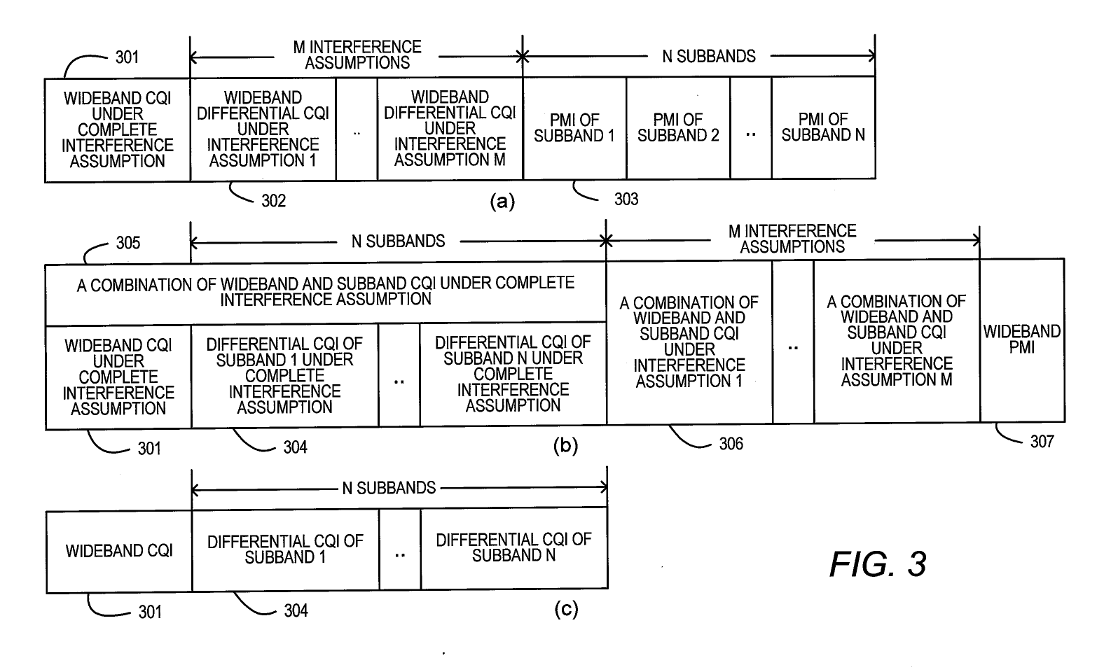

Referring to FIG. 3 in conjunction with FIGS. 1 and 2, the PUSCH-based non-periodic feedback information of the embodiment of this invention is described below. In FIG. 3, M and N are natural numbers.

As illustrated in FIGS. 1 and 2, the receiving antenna 101 of TP receives non-periodic feedback information carried over PUSCH from the UE during the link initialization or downlink data transmission.

Upon the data including the non-periodic feedback information carried over PUSCH being received by the receiving antenna 101 of TP, the data is RF processed and send to the base station which it belongs to. The received data is demodulated and decoded by the base station, and then send to the data and control signal processing module 107 for separating, and the data including non-periodic feedback information is send to the PUSCH information extraction module 110. In the PUSCH information extraction module 110, it is determined that whether the UE is a CoMP user based on the known size of the measurement set of the UE. If it is determined that the UE is a CoMP user, the base station may demultiplex the non-periodic feedback information carried over PUSCH in a predetermined feedback information mode format according to high layer signaling configuration.

When the size of the measurement set is S, the non-periodic feedback information carried over PUSCH includes a number of CSIs linked end to end, wherein the CSIs corresponds to S TPs respectively, as illustrated in table 1 below. The CSIs are order in the index of cell from small to large.

TABLE 1

| | | | |
|---|---|---|---|
| CSI | CSI | CSI | CSI |
| corresponding | corresponding | corresponding | corresponding |
| to TP1 | to TP2 | to TP . . . | to TPS |

The format for the CSI corresponding to each of TPs is determined by a feedback information mode format suitable for CoMP. FIG. 3 illustrates an example of the non-periodic feedback information format suitable for CoMP.

Following, the structure of data field for the newly introduced PUSCH-based non-periodic feedback information format is detailedly described with reference to FIG. 3. However, these are only examples and the present invention is not limited thereto. The non-periodic feedback information illustrated in FIG. 3 is partial information, and the other information that is the same as that in the art will be omitted. Here, the CQI under the complete interference assumption and the CQI under the partial interference assumption included in the non-periodic feedback information are simply referred to as “CQI set”.

As illustrated in FIG. 3(a), in the embodiment of this invention, a newly designed format 1-3 for PUSCH-based non-periodic feedback information mode is introduced, wherein the feedback data consists of data fields (1)-(3) as follows:

(1) Wideband CQI 301 under the complete interference assumption: The number of bits in this data field is determined by the value of RI transmitted separately. If the value of RI is 1, the number of bits in this data field is 4, and if the value of RI is above 1, the number of bits in this data field is 8. Additionally, the procedure of generating the wideband CQI under the complete interference assumption comprises: when the UE is computing the channel SINR, regarding the signals of target TP as useful signals, and regarding the signals of all TPs outside the UE's measurement set and the other TPs inside the UE's measurement set except the target TP as useful signals. This calculation for CQI is consistent with the existing method.

(2) Wideband differential CQI 302 under the partial interference assumption: The number of this data field is determined by the total number of interference assumptions to be measured that configured by the high layer, and the number of bits in each data field is determined by the value of RI transmitted separately. If the value of RI is 1, the number of bits in the data field is 2, and if the value of RI is above 1, the number of bits in the data field is 4. Additionally, the procedure of generating the wideband differential CQI under the partial interference assumption comprises: when the UE is computing the channel SINR, regarding the signals of target TP as useful signals, and regarding the signals of all TPs outside the UE's measurement set and the other TPs inside the UE's measurement set except the target TP as useful signals, thus corresponding to the case of possible TP silent in DPB. There are differences in this CQI due to the different interference assumptions. Since the interference signal strength detected by the UE under the partial interference assumption is low, the SINR increases, and the quantized CQI values would correspond that the CQI value under the complete interference assumption has increased, so that the CQI value can be transmitted by using differential CQI.

(3) Subband PMI 303: The number of this data field depends on the number of frequency subband, and the number, N of frequency subband is determined by the total bandwidth for downlink of system; the number of bits in each data field is determined according to the number of TP antenna and the value of RI transmitted separately, which is consistent with the existing method.

As illustrated in FIG. 3(b), in the embodiment of this invention, a newly designed format 3-3 for PUSCH-based non-periodic feedback information mode is introduced, wherein the feedback data consists of data fields (1)-(3) as follows:

(1) A combination of wideband and subband CQI under the complete interference assumption 305: This data field consists of wideband CQI 301 and a number, N of subband differential CQI 304, the number of data field in the subband differential CQI 304 depends on the number of frequency subband, and the number, N of frequency subband is determined by the total bandwidth for downlink of system. The number of bits in both of the data field is determined by the value of RI transmitted separately. If the value of RI is 1, the number of bits in the data field of wideband CQI 301 is 4, and the number of bits in the subband differential CQI 304 is 2; and if the value of RI is above 1, the number of bits in the data field of wideband CQI 301 is 8, and the number of bits in the subband differential CQI 304 is 4.

(2) A combination of wideband and subband CQI under the partial interference assumption 306: The number of this data field is determined by the total number M of interference assumptions to be measured that configured by the high layer, and each data field also consists of wideband CQI 301 and a number, N of subband differential CQI 304. The number of bits of the combination of wideband and subband CQI under the partial interference assumption 306 is the same as that of the combination of wideband and subband CQI under the complete interference assumption 305.

(3) Wideband PMI 307: The number of this data field is 1, and the number of bits in each data field is determined according to the number of TP antenna and the value of RI transmitted separately, which is consistent with the existing method.

As illustrated in FIG. 3(c), in the embodiment of this invention, a newly designed format 3-0-2 for PUSCH-based non-periodic feedback information mode is introduced, wherein the feedback data consists of data fields (1)-(2) as follows:

(1) Wideband CQI 301: The number of bits in this data field is determined by the value of RI transmitted separately. If the value of RI is 1, the number of bits in the data field is 4, and if the value of RI is above 1, the number of bits in the data field is 8.

(2) Subband differential CQI 304: The number of data field in the subband differential CQI 304 depends on the number of frequency subband, and the number, N of frequency subband is determined by the total bandwidth for downlink of system. The number of bits in this data field is determined by the value of RI transmitted separately. If the value of RI is 1, the number of bits in the data field is 2, and if the value of RI is above 1, the number of bits in the data field is 4.

In the embodiment of this invention, a format 3-0-2 for non-periodic feedback information mode is designed specifically for the aggregated CQI feedback. When calculated, it is assumed that all of TP inside the CoMP measurement set use JT scheme, and use the PMI included in each TP's CSI to precode for providing data transmission to UEs. Because it does not belong to any TP, it needs to be turned on or not by the high-level signaling configuration. When turned on, all the data bits corresponding to the format of feedback information pattern are connected after the data bits of each of TP's CSI, as illustrated in Table 2.

TABLE 2

| | | | | |
|---|---|---|---|---|
| CSI | CSI | CSI | CSI | aggre- |
| corresponding | corresponding | corresponding | corresponding | gated |
| to TP1 | to TP2 | to TP . . . | to TPS | CQI |

As illustrated in FIGS. 1 and 2, the information separated from PUSCH-based non-periodic feedback information may be send to CoMP scheme selection and scheduling module 115 for CoMP scheme selection (step 202). Also, the separated information is send to load state information storage table 113 and channel state information storage table 114 to store for serving in the subsequent process of inquiry.

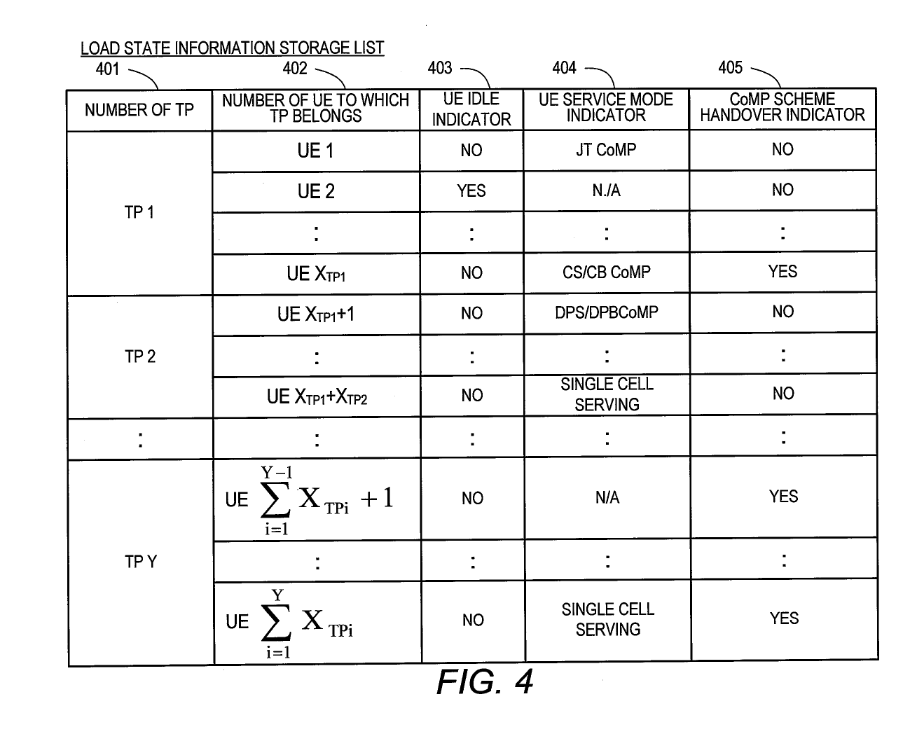

Referring to FIG. 4, the channel state information storage table is described below.

The load state information extracted from non-periodic feedback information that indicates load state of terminals is stored in load state information storage table 113. The load state information includes at least a terminal service mode identifier and a CoMP scheme switching indicator.

FIG. 4 illustrates an example of load state information storage table 113. As shown in FIG. 4, load state information storage table 113 is used to record service condition for each UE in each cell, for example, including TP number 401, the number of UE to which the TP belongs 402, an UE idle indicator 403, UE service mode identifier 404 and a CoMP scheme switching indicator 405.

TP number 401 is used to indicate the serial number of each TP controlled by base station.

The number of UE to which the TP belongs 402 is used to identify the UE to which each TP belongs.

The UE idle indicator 403 is used to identify whether the UE has needs for downlink data transmission currently.

UE service mode identifier 404 is used to indicate the data transmission mode currently in use by the UE, that is, CoMP scheme. When the UE is at the center of cell, there is a greater probability of working in a single cell service mode. When the UE is at the edge of cell, there is a greater probability of working in one of three modes of CoMP, which is CS/CB, DPS/DPB or JT.

A CoMP scheme switching indicator 405 may determine whether the UE has needs for CoMP scheme switching currently based on whether received PUSCH from the UE. If the CoMP scheme switching indicator 405 is “Yes”, when the UE is scheduled, CoMP scheme selection and scheduling module 115 will reselect a CoMP scheme for the UE; if the CoMP scheme switching indicator 405 is “No”, when the UE is scheduled, CoMP scheme selection and scheduling module 115 will not reselect a CoMP scheme for the UE.

In the embodiment of this invention, upon performing the CoMP scheme switching process for the UE, the CoMP scheme switching indicator 405 of the UE will be updated from “Yes” to “No”. Also, upon performing the CoMP scheme selection process for the UE, UE service mode identifier 404 of the UE will be updated.

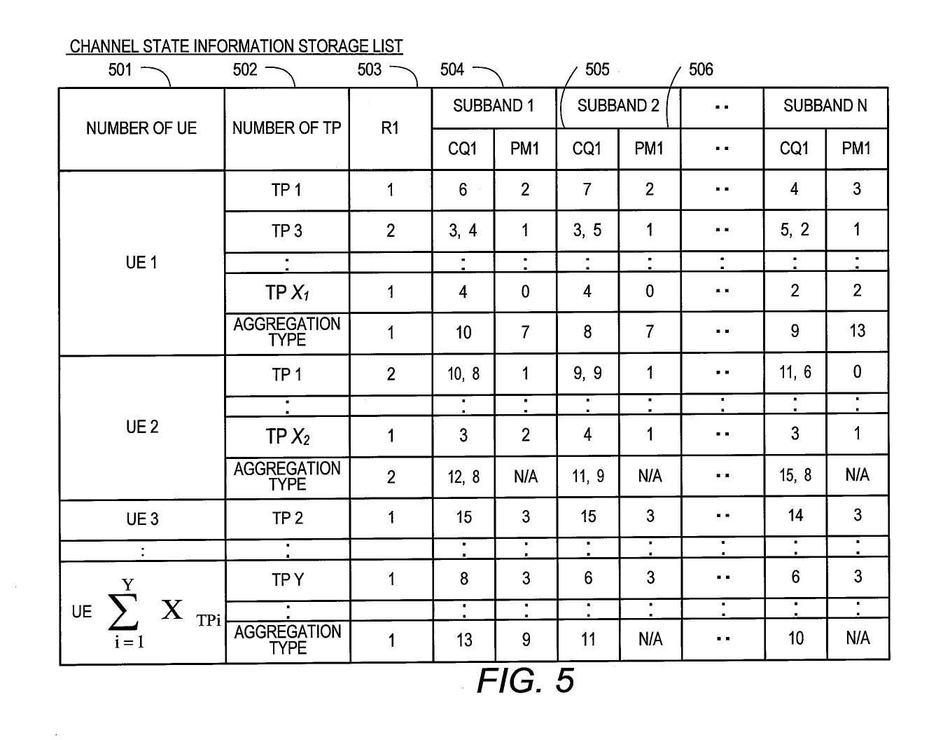

Referring to FIG. 5, the channel state information storage table is described below.

The channel state information CSI extracted from non-periodic feedback information and periodic feedback information that indicates channel state of terminals is stored in channel state information storage table 114. The channel state information CSI includes at least channel rank information RI, a channel quality indicator CQI and a pre-coding matrix indicator PMI.

FIG. 5 illustrates an example of channel state information storage table 114. As illustrated in FIG. 5, channel state information storage table 114 is used to record information about subband CQI and PMI for each TP or aggregated which feedback from each UE, for example, including UE number 501, TP number 502, RI information corresponding to TP 503, subband information corresponding to TP 504. Wherein, the subband information 504 is included.

The UE number 501 is used to indicate the serial number of each UE controlled by the base station.

The TP number 502 is the serial number of TP to which the feedback information from each UE corresponds. With respect to the UE corresponding to CoMP service, the UE's TP number 502 includes “aggregated” feedback.

The RI field 503 is used to record the value of wideband RI for each TP or aggregated field.

The subband information 504 corresponds to each TP or aggregated field, and records subband-specific CQI information 505 or PMI information 506.

In the embodiment of this invention, upon receiving data including PUSCH-based non-periodic feedback information from the UE, base station extract the non-periodic feedback information from the data though PUSCH information extraction module 110, and update the corresponding data field in channel state information storage table 114 based on the information included in the non-periodic feedback information. If the high level signaling do not allow aggregated CQI transmission, the data field of aggregated CQI corresponding to the UE in channel state information storage table 114 will be cleared.

In the embodiment of this invention, upon receiving data including PUCCH-based periodic feedback information from the UE, base station extract the periodic feedback information from the data though PUCCH information collection module 111, and update the corresponding data field in channel state information storage table 114 based on the information included in the periodic feedback information.

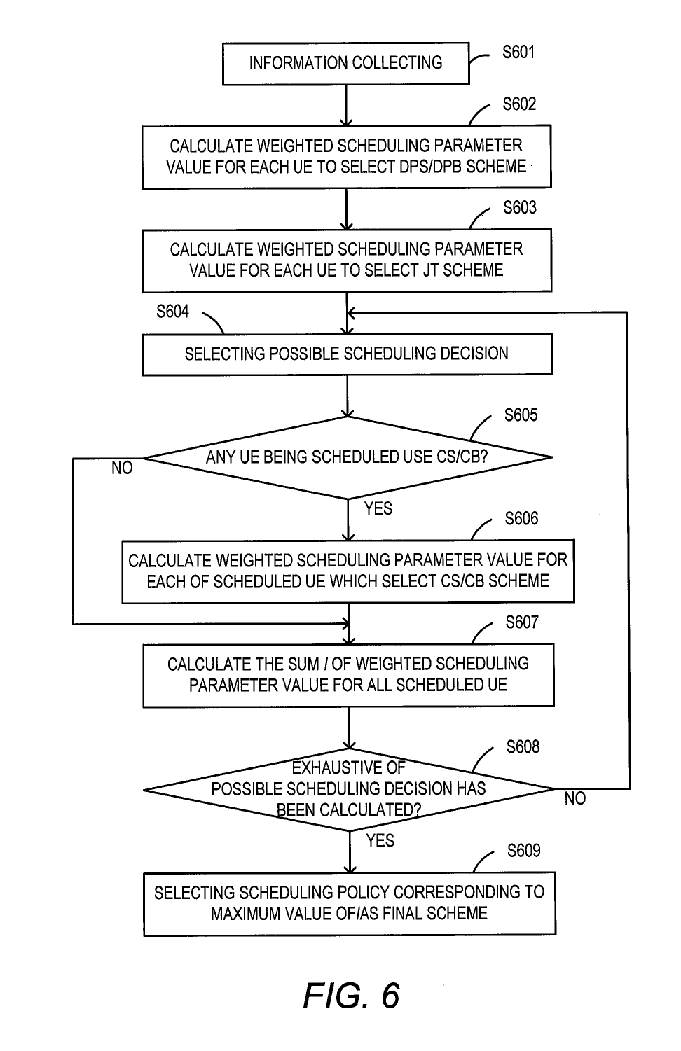

With reference to FIG. 6, illustrated an example of CoMP scheme selection and scheduling by CoMP scheme selection and scheduling module 115 of a base station. However, the present invention is not limited thereto, and that various changes may be made thereto. For example, the order of the steps S602 and step S603 can be changed.

FIG. 6 is a schematic flow diagram illustrating CoMP scheme selection and scheduling by CoMP selection and scheduling module 115. As illustrated in FIG. 6, firstly, CoMP selection and scheduling module 115 collects the required information (step S601) by receiving non-periodic feedback information of particular UE at PUSCH information extraction module 110, collecting the required information from the load state information and channel state information for each UE stored in load state information storage table 113 and channel state information storage table 114.

Next, CoMP scheme selection and scheduling module 115 calculates a Weighted scheduling parameter value for each UE to select DPS/DPB scheme (step S602), and calculates a Weighted scheduling parameter value for each UE to select JT scheme (step S603). Then, CoMP scheme selection and scheduling module 115 obtains all possible scheduling policies based on the collected required information as candidate CoMP scheme, and selects one scheduling policy for subsequent calculation (step S604).

Next, for the selected possible scheduling policy, CoMP scheme selection and scheduling module 115 determines if there is any UE that selects CS/CB mode (step S605). If there is the UE that selects CS/CB mode in the selected scheduling policy (the result of determination at step S605 is “Yes”), CoMP scheme selection and scheduling module 115 calculates a Weighted scheduling parameter value for each of the scheduled UE which select CS/CB scheme (step S606). Then, CoMP scheme selection and scheduling module 115 calculates the sum I of weighted scheduling parameter value for all the scheduled UE in the scheduling policy, and store I temporarily (step S607). If there is no UE that selects CS/CB mode in the selected scheduling policy (the result of determination at step S605 is “No”), proceeding to step S607.

Next, CoMP scheme selection and scheduling module 115 determines whether an exhaustive of possible scheduling policy has been completed (step S608). If CoMP scheme selection and scheduling module 115 determines that an exhaustive of possible scheduling policy has not been completed (the result of determination at step S608 is “No”), returns to step S604, and calculate the remaining scheduling policies. If CoMP scheme selection and scheduling module 115 determines that an exhaustive of possible scheduling policy has been completed (the result of determination at step S608 is “YES”), the value of I generated by different scheduling policies may be compared to select the scheduling policy corresponding to the maximum value of I as the final scheme (step S609). This scheduling policy is that selects one of CS/CB, DPS/DPB and JT for each UE being scheduled and requiring CoMP selection. For the UEs that has completed CoMP selection, it is necessary to update the data fields of UE service mode identifier 404 and the CoMP scheme switching indicator 405 in load state information storage table 113.

In the embodiment of this invention, the term “scheduling policy” refers to a set of the CoMP scheme selected separately by the scheduled UEs. For example, if there are two UEs to be scheduled, the selectable scheduling policies are illustrated in the table below, which contains a total of 9. The selection of CoMP scheme for the scheduled UEs is determined by the data field of the CoMP scheme switching indicator 405 in load state information storage table 113.

| scheduling | CoMP scheme | CoMP scheme |
|---|---|---|
| policy | for UE1 | for UE2 |
| 1 | DPS/DPB | DPS/DPB |
| 2 | DPS/DPB | CS/CB |
| 3 | DPS/DPB | JT |
| 4 | CS/CB | DPS/DPB |
| 5 | CS/CB | CS/CB |
| 6 | CS/CB | JT |
| 7 | JT | DPS/DPB |
| 8 | JT | CS/CB |
| 9 | JT | JT |

In the embodiment of this invention, the selection of the scheduled UE may be based on the existing method, for example, CoMP scheme selection and scheduling module 115 may calculates the corresponding weighted scheduling parameter value and select the scheduled UE in a descending order; as an another example, CoMP scheme selection and scheduling module 115 may select the scheduled UE in accordance with an alternate scheduling method in conjunction with the previous scheduling condition.

As illustrated in FIG. 2, in the embodiment of this invention, for the UEs that have completed the CoMP scheme selection, the base station will inform the UEs of the selected CoMP scheme and the periodic feedback configuration based on the CoMP scheme. Based on the channel state information stored in channel state information storage table 114, the base station can transmit downlink data to the scheduled UE according to the UE service mode identifier 404 in load state information storage table 113 (step S203).

In the embodiment of this invention, if the UE is operating in JT CoMP scheme, PMI of PMI field of the UE's each TP in the channel state information storage table 114 may be used for precoding. If the UE is operating in JT CoMP scheme, the CQI required in the scheduling preferably uses the aggregated CQI of the aggregated CQI field of the UE in the channel state information storage table 114. If the aggregated CQI field of the UE is null, the aggregated CQI required in the scheduling may be generated approximately by the base station based on the CQI information of the CQI field of the UE's each TP.

In the embodiment of this invention, if the UE is operating in DPS/DPB CoMP scheme, the CQI required in the base station scheduling is selected, from a plurality of CQIs corresponding to different interference conditions stored in the CQI field of corresponding TP in the channel state information storage table 114, as the one that is consistent with the scheduling policy according to the final scheduling policy.

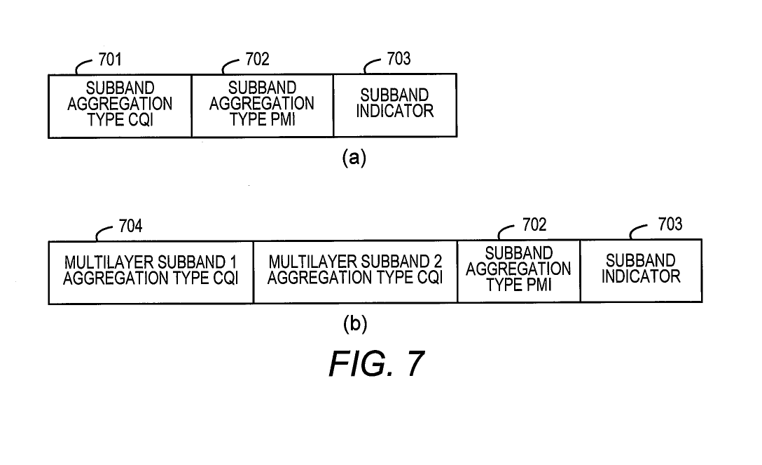

As illustrated in FIGS. 2 and 1, in the embodiment of this invention, during downlink data transmission, a base station receives data including periodic feedback information carried by PUCCH from the UE (step S204). Upon the PUCCH transmitted from the UE being received by the base station, the PUCCH is RF processed and send to the base station which it belongs to. The baseband data is demodulated and decoded by the base station, and then send to the data and control signal processing module 107 for separating, and the data including periodic feedback information is send to the PUCCH information extraction module 111. Based on the high level signaling configuration, the PUCCH information extraction module 111 determines whether the feedback is an aggregated CSI in accordance with the predetermined feedback period and offset, and determines the TP to which this feedback corresponds if the feedback is not an aggregated CSI. Then, based on the high level signaling configuration, the PUCCH information extraction module 111 extracts the non-periodic feedback information carried over PUCCH in accordance with the predetermined format for periodic feedback information mode. Assumed that the UE is configured to work in JT CoMP scheme and use the aggregated CSI feedback, the format for periodic feedback information mode suitable for the UE is illustrated in FIG. 7 as an example. The following composition of its data field is described in detail.

With reference to FIG. 7, the composition of data field for the newly introduced PUCCH-based periodic feedback information format is described with reference to FIG. 3. However, these are only examples and the present invention is not limited thereto. The non-periodic feedback information illustrated in FIG. 7 is partial information, and the other information that is the same as that in the art will be omitted.

As illustrated in FIG. 7(a), in the embodiment of this invention, a format 2-2 for PUCCH-based periodic feedback information mode is introduced, wherein the feedback data consists of data fields (1)-(3) as follows:

(1) The subband aggregated CQI 701: The number of bits in this data field is 4.

(2) The subband aggregated PMI 702: The number of bits in this data field is determined based on the aggregated number of TP antennas and the value of RI transmitted separately, wherein an appropriate codebook is selected according to the aggregated number of TP antennas, and a match number of bits are generated based on the codebook and the value of RI transmitted separately.

(3) The subband indicator 703: This data field is used to indicate where the specific subband for the subband aggregated CQI and PMI of feedback in the frequency domain.

As illustrated in FIG. 3(b), in the embodiment of this invention, a format 2-2 for PUCCH-based periodic feedback information mode may consist of data fields (1)-(3) as follows:

(1) The multilayer subband aggregated CQI 704: The number of bits in this data field is determined based on the value of RI transmitted separately. If the value of RI is 1, the number of bits in this data field is 4; and if the value of RI is above 1, the number of bits in this data field is 7, that is, including a 4-bits CQI for the codeword 0 and a differential CQI for the codeword 1. The method for generating a differential CQI is consistent with existing standards.

(2) The subband aggregated PMI 702: The number of bits in this data field is determined based on an assumption that the downlink data transmission is on two subbands included in the feedback. The number of bits in this data field is determined based on the aggregated number of TP antennas and the value of RI transmitted separately, wherein an appropriate codebook is selected according to the aggregated number of TP antennas, and a match number of bits are generated based on the codebook and the value of RI transmitted separately.

(3) The subband indicator 703: This data field is used to indicate where the specific subband 1 for the subband aggregated CQI and PMI of feedback in the frequency domain.

In the embodiment of this invention, a format 2-2 for periodic feedback information mode is designed specifically for the aggregated CQI feedback. When calculated, it is assumed that all of TPs inside the CoMP measurement set use JT scheme, and use the PMI selected in a codebook matching the sum of the aggregated number of TP antennas to precode for providing data transmission to UEs. The design of format 2-2 for periodic feedback information mode is due to that the aggregated CSI feedback can provide a better performance for JT mode, and requires fewer feedbacks. For the JT CoMP, with use of the aggregated CSI in data transmission, signals can be combined more effective, and the network performance can be further effectively improved.

In the embodiment of this invention, if the JT CoMP scheme is restricted to use only single-layer transmission, the example 1 of feedback data format for the PUCCH feedback information mode should be used for feedback information transmission. Here, it is necessary to redefine a PUCCH format 2, and define a new PUCCH report type to correspond to the subband CQI and subband PMI feedback existing simultaneously.

In the embodiment of this invention, if the JT CoMP scheme is not restricted to use only single-layer transmission, the example 2 of feedback data format for the PUCCH feedback information mode should be used for feedback information transmission. Here, it is necessary to redefine a PUCCH format 3 so that it can support the transmission of feedback information on the basis of the original function, and define a new PUCCH report type to correspond to the subband CQI and subband PMI feedback existing simultaneously. In the example 2 of feedback data format for the PUCCH feedback information mode, the subband indicator should indicate the location of subband 1 in the frequency domain, and the subband 2 should be adjacent to the subband 1. The subband 1 and subband 2 are arranged in frequency domain from low to high order.

In the embodiment of this invention, upon receiving feedback information based on the PUCCH feedback information mode format for the UE, the base station should update the fields of aggregated subband CQI and PMI corresponding to the UE in the channel state information storage table 114.

In the embodiment of this invention, the periodic feedback corresponding to JT CoMP also may use the existing format for feedback information mode, that is, for each of TPs that participate in the CoMP measurement set, the CSI corresponding to the TP may be feedback according to the existing Feedback mode format. Meanwhile, it is necessary to update the fields of CQI and PMI of the TP to which the UE corresponds in the channel state information storage table 114, and delete the data stored in the data field of the UE's aggregated CQI and PMI. Whether using the aggregated feedback in the periodic feedback is totally determined based on the feedback information format used by the base station for periodic feedback.

In the embodiment of this invention, the periodic feedback corresponding to CS/CB and DPS/DPB CoMP may use the existing format for feedback information mode, that is, for each of TPs that participate in the CoMP measurement set, the CSI corresponding to the TP may be feedback according to the existing Feedback mode format. Meanwhile, it is necessary to update the fields of CQI and PMI of the TP to which the UE corresponds in the channel state information storage table 114.

As illustrated in FIG. 2, in the embodiment of this invention, for each received PUCCH, the base station will update the channel state information for the transmitting UE in channel state information storage table 114. After completing the update, based on the channel state information stored in channel state information storage table 114, the base station may perform downlink data transmission to the scheduled UE according to the UE service mode identifier 404 in load state information storage table 113 (step S205).

In the embodiment of this invention, if the UE is operating in JT CoMP scheme, the precoding thereof preferably uses the aggregated CQI of the aggregated PMI data field of the UE in the channel state information storage table 114. If the aggregated PMI field of the UE is null, the PMI of PMI field of the UE's each TP is used for precoding. If the UE is operating in JT CoMP scheme, the CQI required in the scheduling preferably uses the aggregated CQI of the aggregated CQI field of the UE in the channel state information storage table 114. If the aggregated CQI field of the UE is null, the aggregated CQI information required in the scheduling may be determined approximately by the base station based on the CQI information of the CQI field of the UE's each TP. Wherein, the term “aggregated CQI” refers to the CQI with which the plurality of TPs simultaneously transmit data to the UE. The “aggregated PMI” refers to the PMI with which the plurality of TPs simultaneously transmits data to the UE.

### <Central Control Server>

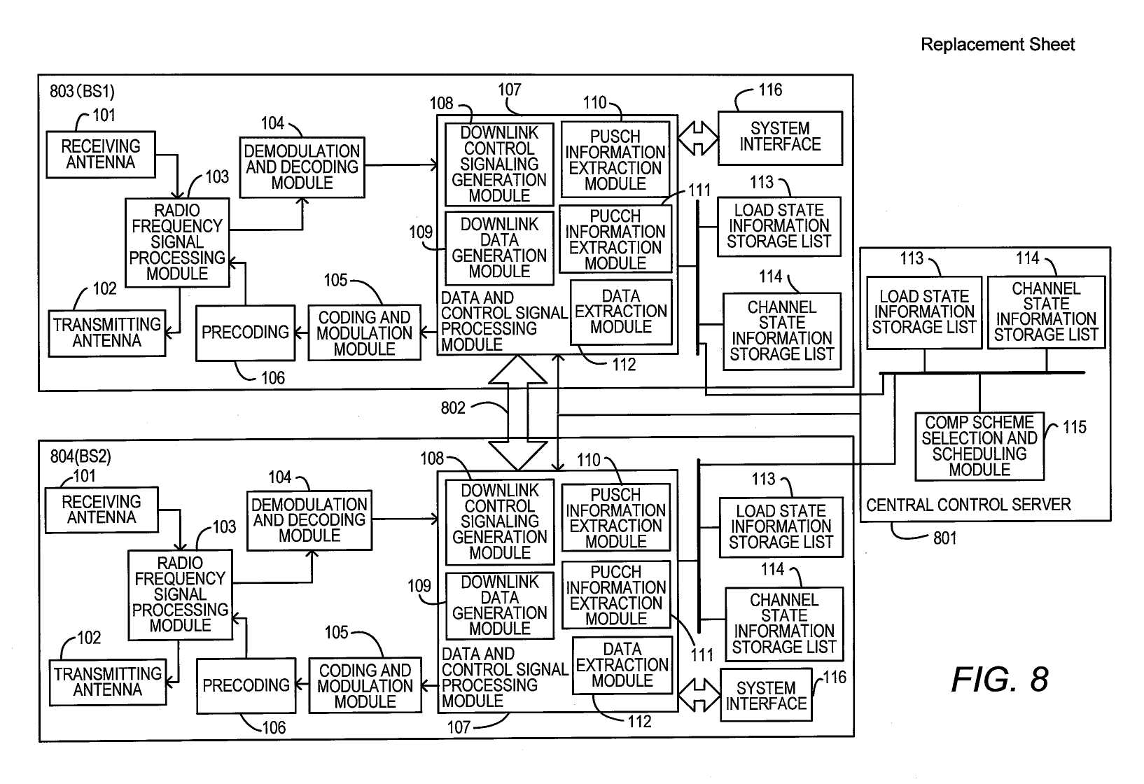

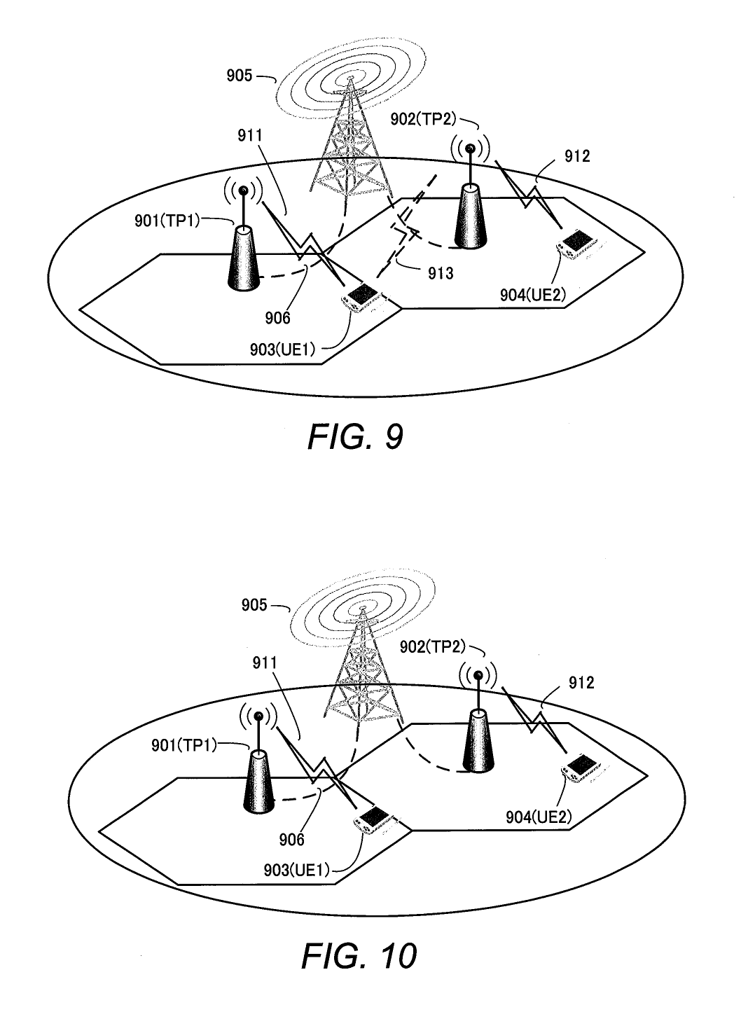

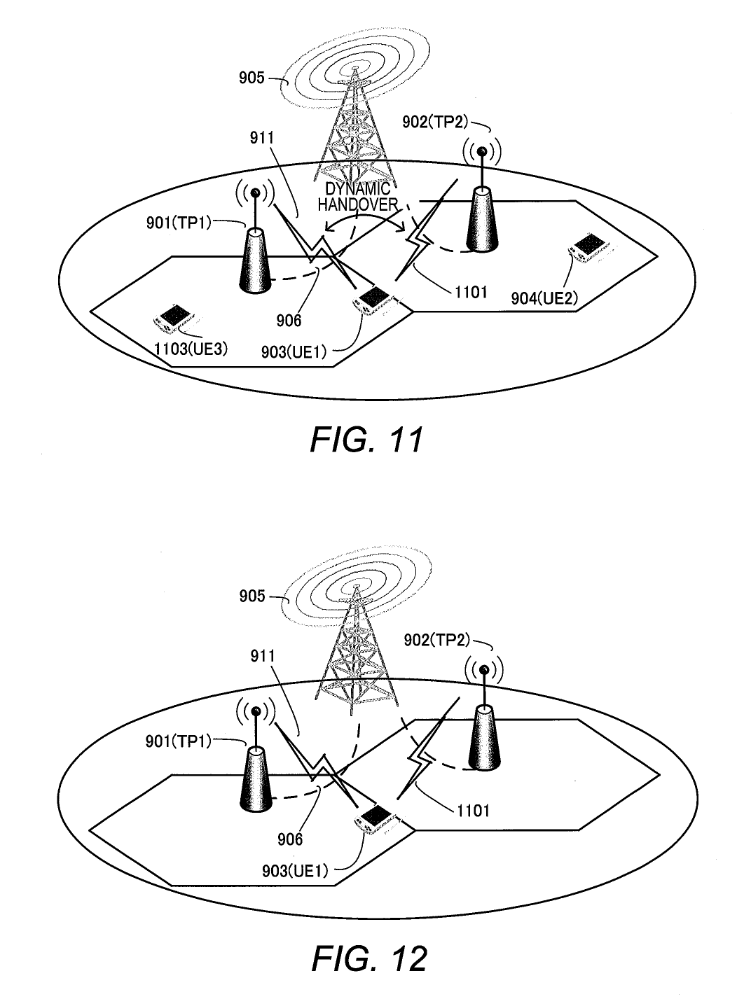

With reference to FIG. 8, a central control server is described in accordance with the embodiment of this invention. The function of CoMP scheme selection and cooperative transmission may be implemented by adding a central control server in system.

FIG. 8 is a schematic diagram illustrating system architecture for a central control server to support use and selection of various CoMP schemes. As illustrated in FIG. 8, a central control server 801 is configured individually so that two base station 803, 804 (hereinafter referred to as “BS1” and “BS2”) can perform CoMP scheme selection and cooperative transmission. The same components as FIG. 1 are denoted with same reference numerals, and the description thereof is omitted

As illustrated in FIG. 8, a base station includes one or more TPs to perform RF band processing and transceiver function. Upon receiving uplink signals, each base station independently perform functions of baseband processing, separating of signaling data etc, and update the load state information storage table 113 and channel state information storage table 114 therein with the obtained specific channel state information.

The central control server 801 may read data from storage table stored in each controlled base station, store the data in the load state information storage table 113 and channel state information storage table 114 in its storage area, select a suitable CoMP scheme for each UE served by each base station through CoMP scheme selection and scheduling module 115 based on the read information, and allocate appropriate radio resources.

The downlink control signaling generation module 108 and downlink data generation module 109 may generate downlink signaling and data respectively based on the results of CoMP scheme selection and scheduling module 115, and share them with the base station with which perform cooperative transmission through interfaces between base stations, and perform downlink data transmission to the scheduled UE after the downlink baseband and RF processing.

In the embodiment of this invention, if the CoMP scheme selection and transmission across base stations is implemented by introducing a central control server, the data field of TP number also may be used to store the TP number of all the TPs under the rearranged base station controlled by the same central control server.

### INDUSTRIAL APPLICABILITY

The embodiment of this invention relates generally to a method, base station device and central control server for transmitting data to a terminal by a base station acted as wireless communication device, and more particularly, to a method, base station device and central control server for transmitting data to a terminal by a base station which is able to select a appropriate Coordinated Multi-Point scheme from a plurality of Coordinated Multi-Point schemes for downlink data transmission.

1. A base station apparatus that uses a plurality of coordinated Multiple Points (CoMP) schemes, and is connected to a plurality of subordinate transmission points for transmitting data, comprising:
a transceiver unit, located at the transmission point, that receives and transmits data from and to a terminal;
a data processing unit that extracts non-periodic feedback information and periodic feedback information from the data received via the transceiver unit from the terminal;
a CoMP scheme selection unit that, upon receiving the non-periodic feedback information from the terminal, extracts channel state information and load state information for the terminal from the non-periodic feedback information, calculates respective weighted scheduling parameter value for each of the plurality of CoMP schemes based on the extracted channel state information and the load state information, and selects a CoMP scheme to be applied to the terminal from the plurality of CoMP schemes based on the calculated weighted scheduling parameter value; and
a scheduling unit that performs scheduling with use of the selected CoMP scheme based on the non-periodic feedback information and periodic feedback information, and transmits data to the terminal via a corresponding transceiver unit.

2. The base station apparatus according to claim 1, further comprising
a storage unit that stores a channel state information storage table and a load state information storage table, wherein
the channel state information storage table stores channel state information extracted from the non-periodic feedback information and the periodic feedback information which indicates channel state of each terminal, and the channel state information includes channel rank information, a channel quality indicator and a pre-coding matrix indicator; and
the load state information storage table stores load state information extracted from the non-periodic feedback information and the periodic feedback information which indicates load state of each terminal, and the load state information includes a service mode indicator and a CoMP scheme switching indicator of the each terminal.

3. The base station apparatus according to claim 1, wherein,
the periodic feedback information includes at least one of an aggregated channel quality indicator defined as a channel quality indicator with which the plurality of the transmission points simultaneously transmit data to the same terminal, and an aggregated pre-coding matrix indicator defined as a pre-coding matrix indicator with which the plurality of the transmission points simultaneously transmit data to the same terminal.

4. The base station apparatus according to claim 1, wherein,
the non-periodic feedback information includes at least one of a set of channel quality indicators including a channel quality indicator under complete interference assumption and a channel quality indicator under partial interference assumption, and an aggregated channel quality indicator defined as an aggregated channel quality indicator with which the plurality of the transmission points simultaneously transmit data to the same terminal.

5. The base station apparatus according to claim 2, wherein
the CoMP scheme selection unit:
calculates at least one of a weighted scheduling parameter value for use in selecting Dynamic Point Selection/Blanking scheme and a weighted scheduling parameter value for use in selecting Joint Transmission scheme based on the non-periodic feedback information and the channel state information and load state information of each terminal;
obtains a plurality of CoMP candidates based on the channel state information and the load state information of each terminal;
in case where there is a Centralized Scheduling/Beamforming scheme in the plurality of CoMP candidates, calculates a weighted scheduling parameter value for use in selecting the Centralized Scheduling/Beamforming scheme; and
calculates the sum of the weighted scheduling parameter value for each of the CoMP candidates respectively, and selects a CoMP scheme to be applied to the terminal from the plurality of CoMP scheme candidates based on the sum of weighted scheduling parameter value.

6. A method for transmitting data to a terminal by a base station comprising:
a non-periodic feedback information receiving step of receiving non-periodic feedback information via a transceiver unit from the terminal;
a CoMP scheme selecting step of, upon receiving the non-periodic feedback information from the terminal, extracting channel state information and load state information for the terminal from the non-periodic feedback information, calculating respective weighted scheduling parameter value for each of the plurality of CoMP schemes based on the extracted channel state information and the extracted load state information, and selecting a CoMP scheme to be applied to the terminal from the plurality of CoMP schemes based on the calculated weighted scheduling parameter value;
a periodic feedback information receiving step of receiving periodic feedback information from the terminal; and
a scheduling step of allocating scheduling with use of the selected CoMP scheme based on the non-periodic feedback information and the periodic feedback information, and transmitting data to the terminal via a corresponding transceiver unit.

7. The method according to claim 6, further comprising a step of, after selecting the CoMP scheme to be applied to the terminal, transmitting the selected CoMP scheme and corresponding configuration for periodic feedback information to the terminal.

8. The method according to claim 6, wherein,
the base station stores a channel state information storage table and a load state information storage table;
the channel state information storage table stores channel state information extracted from the non-periodic feedback information and the periodic feedback information which indicates channel state of each terminal, and the channel state information includes channel rank information, a channel quality indicator and a pre-coding matrix indicator; and
the load state information storage table stores load state information extracted from the non-periodic feedback information and the periodic feedback information which indicates load state of each terminal, and the load state information includes a service mode indicator and a CoMP scheme switching indicator of the each terminal.

9. The method according to claim 8, wherein, the CoMP scheme selecting step including steps of:
calculating at least one of a weighted scheduling parameter value for use in selecting Dynamic Point Selection/Blanking scheme and a weighted scheduling parameter value for use in selecting Joint Transmission scheme, based on the non-periodic feedback information and the channel state information and load state information of each terminal;
obtaining a plurality of CoMP candidates based on the channel state information and load state information of each terminal;
in case where there is a Centralized Scheduling/Beamforming scheme in the plurality of CoMP candidates, calculating a weighted scheduling parameter value for use in selecting the Centralized Scheduling/Beamforming scheme; and
calculating the sum of the weighted scheduling parameter value for each of the CoMP candidates respectively, and selecting a CoMP scheme to be applied to the terminal from the plurality of CoMP scheme candidates based on the sum of weighted scheduling parameter value.

10. The method according to claim 6, wherein,
the periodic feedback information includes at least one of an aggregated channel quality indicator defined as a channel quality indicator with which the plurality of the transmission points simultaneously transmit data to the same terminal, and an aggregated pre-coding matrix indicator defined as a pre-coding matrix indicator with which the plurality of the transmission points simultaneously transmit data to the same terminal.

11. The method according to claim 6, wherein,
the non-periodic feedback information includes at least one of a set of channel quality indicators including a channel quality indicator under complete interference assumption and a channel quality indicator under partial interference assumption and an aggregated channel quality indicator defined as an aggregated channel quality indicator with which the plurality of the transmission points simultaneously transmit data to the same terminal.

12. A central control server coupled to a plurality of the base station that couples to a terminal, comprising:
a coordinated Multiple Points (CoMP) scheme selection unit configured to extract channel state information and load state information for the terminal from the non-periodic feedback information obtained by the base station from the terminal, calculate respective weighted scheduling parameter value for each of the plurality of CoMP schemes based on the extracted channel state information and the load state information, and select a CoMP scheme to be applied to the terminal from the plurality of CoMP schemes based on the calculated weighted scheduling parameter value; and
a scheduling unit configured to allocate scheduling with the selected CoMP scheme based on the non-periodic feedback information and periodic feedback information obtained by the base station from the terminal, and notify a corresponding base station of transmitting data to the terminal.

13. The central control server according to claim 12, wherein,
the central control server further stores a channel state information storage table and a load state information storage table;
the channel state information storage table stores channel state information extracted from the non-periodic feedback information and the periodic feedback information which indicates channel state of each terminal, and the channel state information includes channel rank information, a channel quality indicator and a pre-coding matrix indicator; and
the load state information storage table stores load state information extracted from the non-periodic feedback information and the periodic feedback information which indicates load state of each terminal, and the load state information includes service mode indicator and a CoMP scheme switching indicator of the each terminal.

14. The central control server according to claim 13, wherein the CoMP scheme selection unit is further configured to:
calculate at least one of a weighted scheduling parameter value for use in selecting Dynamic Point Selection/Blanking scheme and a weighted scheduling parameter value for use in selecting Joint Transmission scheme based on the non-periodic feedback information and the channel state information and load state information of each terminal;
obtain a plurality of CoMP candidates based on the channel state information and load state information of each terminal;
in case where there is a Centralized Scheduling/Beamforming scheme in the plurality of CoMP candidates, calculate a weighted scheduling parameter value for use in selecting the Centralized Scheduling/Beamforming scheme; and
calculate the sum of the weighted scheduling parameter value for each of the CoMP candidates respectively, and select a CoMP scheme to be applied to the terminal from the plurality of CoMP scheme candidates based on the sum of weighted scheduling parameter value.

15. The central control server according to claim 12, wherein
the periodic feedback information includes at least one of an aggregated channel quality indicator defined as a channel quality indicator with which the plurality of the transmission points simultaneously transmit data to the same terminal, and an aggregated pre-coding matrix indicator defined as a pre-coding matrix indicator with which the plurality of the transmission points simultaneously transmit data to the same terminal.

16. The central control server according to claim 12, wherein
the non-periodic feedback information includes at least one of a set of channel quality indicators including a channel quality indicator under complete interference assumption and a channel quality indicator under partial interference assumption, and an aggregated channel quality indicator defined as an aggregated channel quality indicator with which the plurality of the transmission points simultaneously transmit data to the same terminal.
